(19) United States
(12) Patent Application Publication
(10) Pub. No.: US 2021/0020386 A1
(43) Pub. Date: Jan. 21, 2021

(54) MEMS MAGNETIC SWITCH WITH PERMEABLE FEATURES

(71) Applicant: Innovative Micro Technology, Goleta, CA (US)

(72) Inventor: Christopher GUDEMAN, Lompoc, CA (US)

(73) Assignee: Innovative Micro Technology, Goleta, CA (US)

(21) Appl. No.: 16/931,498

(22) Filed: Jul. 17, 2020

Related U.S. Application Data
(60) Provisional application No. 62/875,747, filed on Jul. 18, 2019.

(51) Int. Cl. H01H 1/00; H01H 11/04

(52) U.S. Cl. CPC H01H 1/0036; H01H 11/04; H01H 1/20; H01H 2229/016; H01H 2229/014

(57) ABSTRACT

Systems and methods for forming a magnetostatic MEMS switch include a movable structure formed in a top surface of a substrate, wherein the movable structure is coupled to the substrate by a plurality of restoring springs anchored to the substrate, a stationary structure formed in the same top surface of the substrate, a conductive shunt bar having a characteristic dimension of about 100 um, wherein the shunt bar is disposed on the movable structure adjacent to the gap, an input electrode and an output electrode disposed on the stationary structure and separated by a distance of about 100 um; and a plurality of permeable magnetic features inlaid into the stationary and movable structures, wherein the movable structure is configured to move relative to the stationary structure by interaction of the permeable features with an applied magnetic field, thereby closing the gap and electrically coupling the input and output electrodes across the conductive shunt bar.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a microelectromechanical systems (MEMS) switch device, and its method of manufacture.

Microelectromechanical systems are devices often having moveable components which are manufactured using lithographic fabrication processes developed for producing semiconductor electronic devices. Because the manufacturing processes are lithographic, MEMS devices may be made in very small sizes, and in large quantities. MEMS techniques have been used to manufacture a wide variety of sensors and actuators, such as accelerometers and electrostatic cantilevers.

MEMS techniques have also been used to manufacture electrical relays or switches of small size, generally using an electrostatic actuation means to activate the switch. MEMS devices often make use of silicon-on-insulator (SOI) wafers, which are a relatively thick silicon “handle” wafer with a thin silicon dioxide insulating layer, followed by a relatively thin silicon “device” layer. In the MEMS devices, a thin cantilevered beam of silicon may be etched into the silicon device layer, and a cavity is created adjacent to the thin beam, typically by etching the thin silicon dioxide layer below it to allow for the electrostatic deflection of the beam. Electrodes provided above or below the beam may provide the voltage potential which produces the attractive (or repulsive) force to the cantilevered beam, causing it to deflect within the cavity.

One known embodiment of such an electrostatic relay is disclosed in U.S. Pat. No. 6,486,425 to Seki. The electrostatic relay described in this patent includes a fixed substrate having a fixed terminal on its upper surface and a moveable substrate having a moveable terminal on its lower surface. Upon applying a voltage between the moveable electrode and the fixed electrode, the moveable substrate is attracted to the fixed substrate such that an electrode provided on the moveable substrate contacts another electrode provided on the fixed substrate to close the microrelay.

However, to fabricate the microrelay described in U.S. Pat. No. 6,486,425, the upper substrate must be moveable, so that the upper substrate must be thin enough such that the electrostatic force may cause it to deflect. The moveable substrate is formed from a silicon-on-insulator (SOI) wafer, wherein the moveable feature is formed in the silicon device layer, and the SOI wafer is then adhered to the fixed substrate. The silicon handle wafer and silicon dioxide insulating layer are then removed from the SOI wafer, leaving only the thin silicon device layer which forms the moveable structure.

Many other MEMS switches have been developed. Many of these switches are electrostatic in nature, and thus require the presence of an electric field. This field is generally generated between to microfabricated parallel plate electrodes. As a result, an electrical connection must be made to both plate electrodes. This adds significant cost and complexity to the devices.

Thus the MEMS switch is desirable which does not require these connections.

### SUMMARY

The systems and methods described here form an electromagnetic MEMS switch using magnetic actuation. Since magnetic effects are action-at-a-distance, the switch does not need power or electricity coupled to the switch. Instead, application of a magnetic field generated by a detached source of magnetic flux may open and close the switch. The switch may make use of a movable plate inlaid with magnetically permeable material to raise and lower a shunt bar across two electrical contacts. Accordingly, this magnetic switch may address unique applications, in automotive and residential structures, for example. The word “plate” is used to describe the movable structure because during fabrication, the movable structure may be formed in the surface of a flat, planar substrate. As a result, the movable structure may be flat, and planar, or plate-like.

Accordingly, the device described here is a switch that may be configured either as a “normally closed” switch that, in the quiescent position, there is an electrical path between the fixed contacts, or as a “normally open” switch wherein there is no path in the quiescent position. For the normally closed switch, when the actuation force is applied to the movable plate, the plate (and shunt bar) are lifted up and off the contacts, opening the switch. For the normally open switch, the movable plate (and shunt bar) are generally held aloft of the contacts until the switch is actuated. The actuating force may be magnetic.

Large scale electromagnetic switches are known, such as Reed relays. Electromagnetic forces used in Reed relays may require high currents; typically 30 mA are needed to generate sufficient force to overcome the supporting spring counter-force.

However, the systems described here has a novel architecture and small size, such that no power source is needed or much more modest currents are needed. The device may be fabricated on semiconductor substrates using lithographic techniques well known in the art.

The device described here may have a movable planar structure adjacent to a stationary, planar structure. The movable feature may be spaced apart from the stationary feature by a gap, and the movable feature may configured to move toward the stationary feature to close the gap. The gap closure may occur upon application of an external magnetic field.

Both the movable structure and the stationary structure may have a permeable material formed therein. The permeable features may be shaped to reduce the reluctance of the magnetic flux path and guide the flux of an external magnetic field across the gaps in the structure. Upon application of the magnetic field, field lines are routed from the magnetic source to the stationary permeable features, across the gap, and to the permeable material inlaid into the movable feature.

Accordingly, when an external magnetic field is applied to the structure, the permeable features act to guide and concentrate the flux across the gap, because the presence of the permeable material creates a lower reluctance path for the magnetic flux. Because of the flux gradient, a force arise in the movable structure, drawing it in a direction so as to close the gap. This motion may also drive a shunt bar across an input and output electrode, thus closing the switch by shorting the input to the output electrode. Alternatively, the actuation may lift or separate the shunt bar from the contacts, thereby opening a normally closed switch.

Accordingly, a magnetic MEMS device is disclosed, which may include a movable structure formed in a substrate, wherein the movable plate is coupled to the first substrate by a plurality of restoring springs into the substrate. Permeable magnetic material may be inlaid into the stationary and movable structures.

The MEMS magnetic switch may be operated by disposing a source of magnetic field gradient in a vicinity of the MEMS magnetic switch, wherein the gradient is sufficient to move the movable structure and either open or close the switch.

A method is also disclosed for fabricating the magnetic MEMS switch. The method may include forming a movable structure and a stationary structure on a substrate, wherein the movable structure is coupled to the substrate by a plurality of restoring springs and separated from the stationary structure by a gap. The method may also include forming an inlaid magnetic material inlaid into the movable and stationary structures. The method may also include forming an inlaid conductive material to form the shunt bar and the input and output electrodes. The method may also include applying a magnetic field to the movable and stationary structures, so as to cause the movable structure to be drawn toward the stationary structure, thus either opening or closing the switch.

The switches formed by this method are generally planar, that is, they are fabricated in the top surface of a generally planar semiconductor substrate. The motion induced by actuation may also fall in a plane parallel to this substrate surface.

These and other features and advantages are described in, or are apparent from, the following detailed description.

### BRIEF DESCRIPTION OF THE DRAWINGS

Various exemplary details are described with reference to the accompanying drawings, which however, should not be taken to limit the invention to the specific embodiments shown but are for explanation and understanding only.

FIG. 1 is a simplified illustrative conceptual view of a magnetic MEMS switch device;

FIG. 2 is a simplified illustration of a first step in the fabrication of a MEMS magnetic switch;

FIG. 3 is a simplified illustration of a second step in the fabrication of a MEMS magnetic switch;

FIG. 4 is a simplified illustration of a third step in the fabrication of a MEMS magnetic switch;

FIG. 5 is a simplified illustration of a fourth step in the fabrication of a MEMS magnetic switch;

FIG. 6 is a simplified illustration of a fifth step in the fabrication of a MEMS magnetic switch;

FIG. 7 is a simplified illustration of a sixth step in the fabrication of a MEMS magnetic switch;

FIG. 8 is a simplified illustration of a seventh step in the fabrication of a MEMS magnetic switch;

FIG. 9 is a simplified illustration of a eighth step in the fabrication of a MEMS magnetic switch;

FIG. 10 is a simplified illustration of a ninth step in the fabrication of a MEMS magnetic switch;

FIG. 11 is a simplified illustration of a tenth step in the fabrication of a MEMS magnetic switch;

FIG. 12 is a simplified illustration of a eleventh step in the fabrication of a MEMS magnetic switch;

FIG. 13 is a simplified illustration of a twelfth step in the fabrication of a MEMS magnetic switch;

FIG. 14 is a simplified illustration showing further detail of the MEMS magnetic switch in the open position; and

FIG. 15 is a simplified illustration showing further detail of the MEMS magnetic switch in the closed position.

It should be understood that the drawings are not necessarily to scale, and that like numbers maybe may refer to like features.

### DETAILED DESCRIPTION

A structure and process are described and directed to a microfabricated electrical switch which is operated by exposure to a magnetic field. The presence of the field may act to open or close the switch, depending on its configuration.

The following discussion presents a plurality of exemplary embodiments of the novel photolithographically fabricated dual substrate MEMS magnetic switch. The following reference numbers are used in the accompanying figures to refer to the following:

| | |
|---|---|
| 100 | glass substrate |
| 30 | silicon layer |
| 40 | adhesive layer |
| 300 | silicon substrate |
| 32, 34, 36 | voids for plating NiFe |
| 42, 44 | voids for plating gold |
| 62, 66, 72, 76 | spring beams |
| 64, 68, 74, 78 | anchor points |
| 460 | shunt bar |
| 470 | input, output electrodes |
| 500 | MEMS magnetic switch |
| 600 | external source of magnetic flux |

The magnetic switch will first be described in general terms. A method for making the MEMS magnetic switch will then be described in some detail. Lastly, an embodiment of the magnetic MEMS switch will be described in considerable detail.

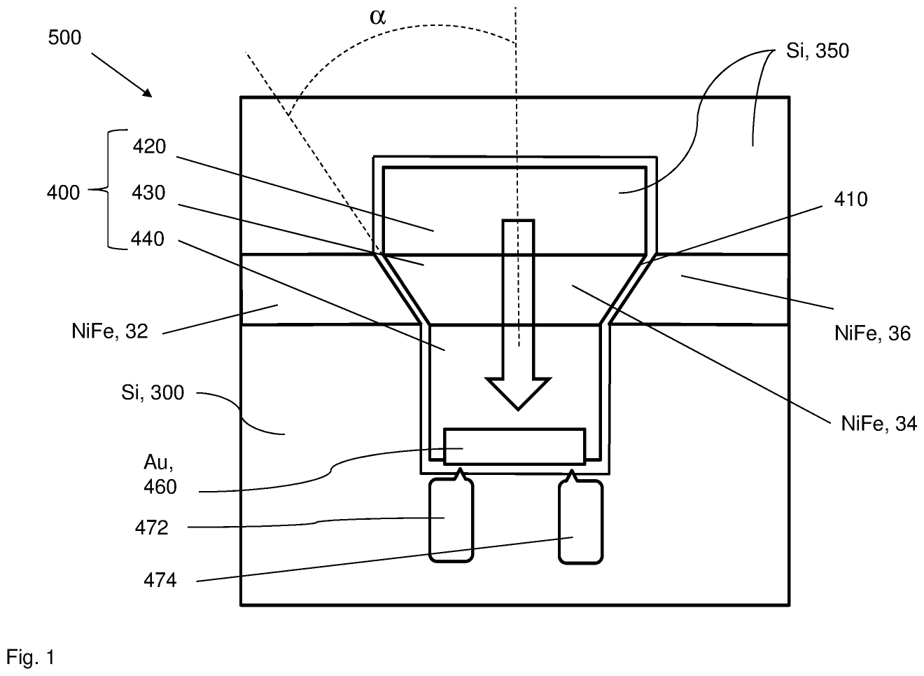

FIG. 1 is a simplified diagram of a MEMS magnetic switch which may be fabricated using MEMS lithographic fabrication tools and processes. The switch may be sensitive to the presence of a magnetic field, such that a set of contact points is opened (or closed) in the presence of a magnetic field. The switch may then be closed (or opened) when the field is removed. Large scale, macroscopic magnetic switches are known, for example, Reed relays are used as proximity sensors, wherein a conductive bar moves to close a set of contacts in the presence of a magnetic field. In the device described here, the overall dimensions of the switch are much smaller, and the device may be made inexpensively and in large quantities to achieve economies of scale. Such economies have been enjoyed for years in integrated circuit chips, which use similar lithographic processing techniques.

Because of the unique architecture of the switch, it made be fabricated in the top surface of a silicon substrate. The motion of the switch as it opens and closes may be parallel to this surface.

In this MEMS magnetic switch, a permeable material, that is, a material that responds to a magnetic field by acquiring a large internal magnetization, may be inlaid into a silicon substrate. This inlaid material may be disposed in a movable structure and in proximity to another stationary inlaid magnetic material. The situation may be as shown in FIG. 1. The movable structure 400 comprises an inlaid permeable feature 34. This movable permeable feature 34 is directly adjacent to similar but stationary permeable features 32 and 36.

Three regions of permeable material 32, 34 and 36 may be separated by a small gap 410. When a source of magnetic flux is placed in proximity to this structure, the flux will travel preferentially through the permeable structures 32, 34 and 36. A feature of magnetically susceptible materials such as permeable materials 32, 34 and 36, is that they are drawn towards areas of flux gradient, i.e. increasing flux density. Because of the focusing effects of permeable materials 32 and 36, the permeable material 34 will be drawn downward in order to decrease the overall magnetostatic energy

A shunt bar 460 may also be formed in the movable structure 400, shown in FIG. 1. The shunt bar may be separated by the gap 410 but disposed adjacent to two contacts 472 and 474. The shunt bar may be moved up and down in the gap 410 by the application and removal of a magnetic field, thus closing and opening the contacts 472 and 474.

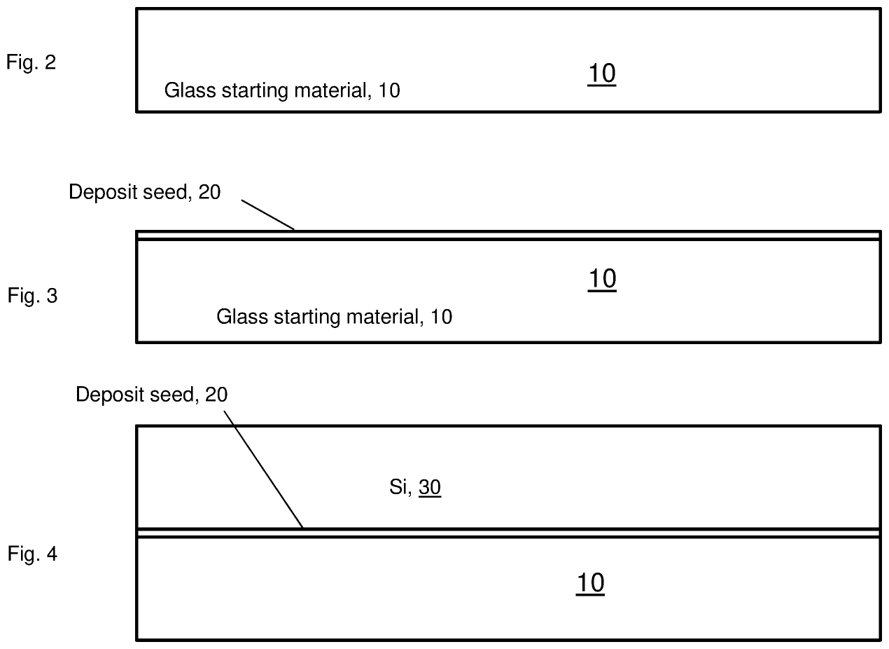

FIG. 2 is a cross-sectional diagram of the starting material of the process for forming the MEMS magnetic switch. The starting material might be, for example, a glass substrate, 10. In some embodiments, the glass substrate may be Borofloat® Silica, manufactured by Schott. BOROFLOAT® is a high quality borosilicate glass with outstanding properties for a wide-range of applications. This float glass is manufactured by SCHOTT Technical Glass Solutions GmbH using the its microfloat process, which results in a homogeneous material that has an excellent mirror-like surface, a high degree of flatness and an outstanding optical quality.

As shown in FIG. 3, a seed layer 20 may then be deposited on the top of the glass substrate material, 10. The seed layer may be for example a metal such as gold. The purpose of the seed layer is to provide a metallic electrode for a plating operation to come, which will form the features shown in FIG. 1.

Prior to depositing the seed layer, an adhesion layer of, for example, titanium about/10-50 nm thick may be deposited. This material may have a strong affinity to the substrate surface and thus help adhere the deposited materials to the substrate.

The adhesion layer may be followed by a diffusion barrier layer such as titanium/tungsten alloy, also between about 10 and about 50 nm thick. Finally, a seed layer, for example gold (Au) may be deposited over the entire surface. The gold may be, for example, 100-200 nm thick. These materials may be sputter deposited for example.

FIG. 4 is a cross-sectional diagram showing a next step in the process for creating the magnetic MEMS switch. A second substrate, for example silicon, 30, maybe bonded to the first substrate across the seed layer, 20. The bonding mechanism may be an anodic bond, for example. In an anodic bond, the silicon substrate is allowed to oxidize at its surface, such that the silicon dioxide on the silicon substrate becomes physically connected to the oxide of the glass substrate. Silicon, for example, is known to form such an anodic bond when place adjacent to an oxide material and a voltage is applied to the silicon and the temperature is raised to about 250-400 degrees centigrade. The seed layer 20 may be patterned in areas where the silicon surface exposure is needed for the bonding.

Anodic bonding is a wafer bonding process to seal glass to either silicon or metal without introducing an intermediate layer. It is commonly used to seal glass to silicon wafers in electronics and microfluidics. This bonding technique, also known as field assisted bonding or electrostatic sealing, is mostly used for connecting silicon/glass and metal/glass through electric fields. The requirements for anodic bonding are clean and even wafer surfaces and atomic contact between the bonding substrates through a sufficiently powerful electrostatic field. Also necessary is the use of borosilicate glass containing a high concentration of alkali ions. The coefficient of thermal expansion (CTE) of the processed glass needs to be similar to those of the bonding partner.

Anodic bonding can be applied with glass wafers at temperatures of 250 to 400° C. or with sputtered glass at 400° C. Structured borosilicate glass layers may also be deposited by plasma-assisted e-beam evaporation.

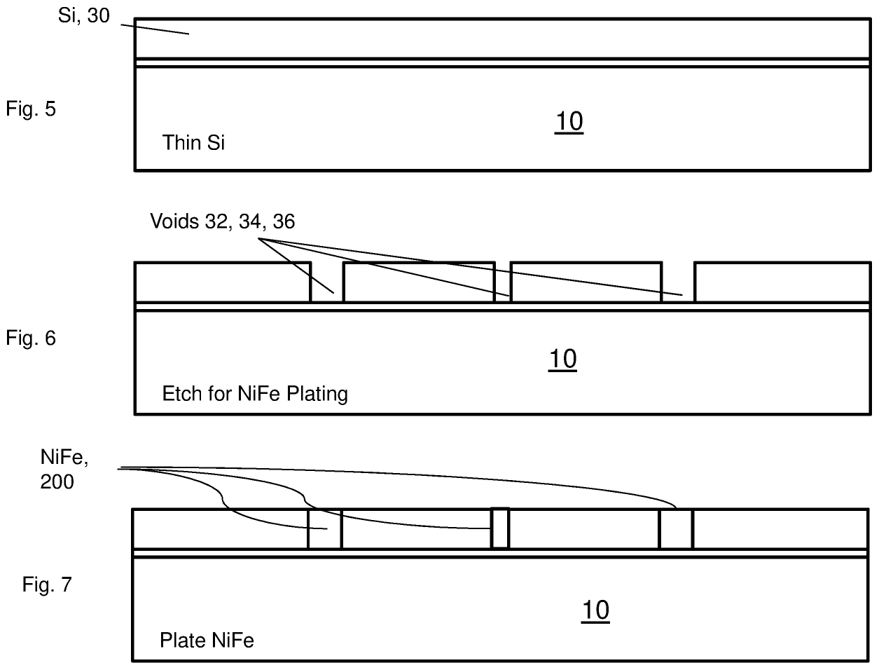

FIG. 5 is a cross sectional diagram of another step in the process for forming the magnetic MEMS switch. In this step, the second substrate, silicon 30, maybe thinned by grinding for example, to a sickness whereby lithography can be conveniently performed. The thickness of the silicon layer 30 may be about 50-100 μm, after thinning.

FIG. 6 is a cross-sectional diagram illustrating a next step in the method for forming the magnetic MEMS switch. In this step, a pattern is created in the silicon layer, 30, by etching through the silicon, 30. The etching process may be performed through a patterned photoresist mask for example. This etching may be done by, for example, deep reactive etching (DRIE), which is well known in the art. This etching step may create voids 34, 36 and 38 in the silicon layer, exposing the seed layer at the bottom of the void.

The dimensions of the voids 32, 34 and 36 may be about, for example, 50-200 microns wide and through the entire depth of the silicon layer 30, so about 50 microns deep.

FIG. 7 shows a next step in the process for forming the magnetic MEMS switch. In FIG. 7, a permeable material may be inlaid into the voids 32, 24 and 36. Nickel iron, permalloy for example (80% nickel and 20% iron) is a common ferroelectric material. Permalloy is notable for its very high magnetic permeability, which makes it useful as a magnetic core material in electrical and electronic equipment, and also in magnetic shielding to block magnetic fields. Commercial permalloy alloys typically may have relative permeability of up to around 100,000, compared to several thousand for ordinary steel. See https://en.wikipedia.org/wiki/Permalloy. In addition to high permeability, its other magnetic properties are low coercivity, near zero magnetostriction, and significant anisotropic magnetoresistance. Permalloy is readily plateable, making it an attractive material in this application. However, other permeable materials may also be used.

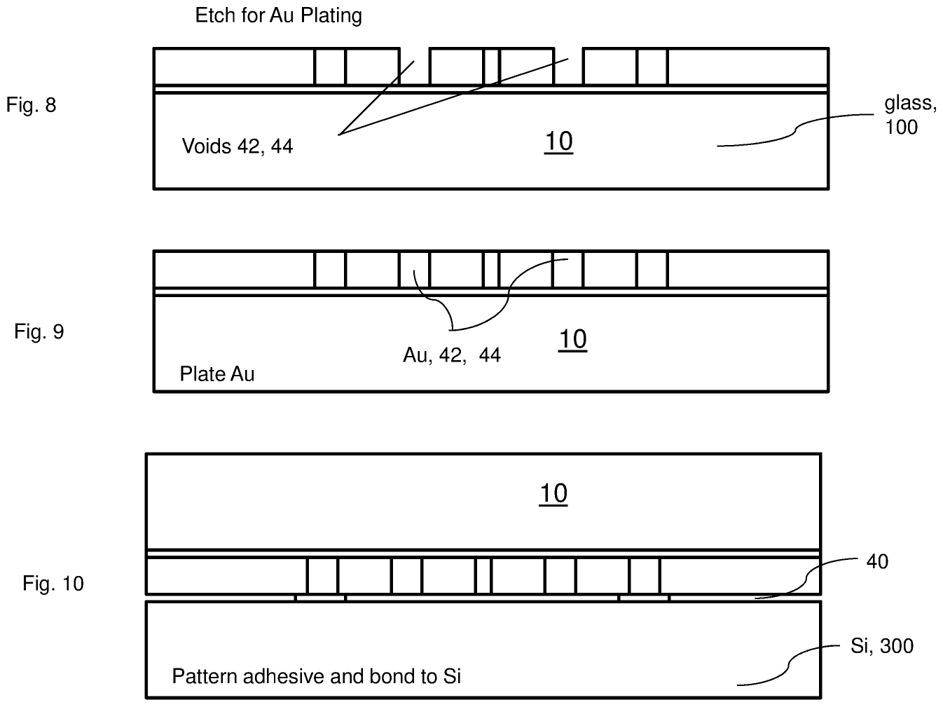

Accordingly, the permeable magnetic material is plated into the voids which were formed the etching process of FIG. 6. This NiFe layer may be plated in a plating bath, using the seed layer, 20, as the plating electrode. By putting a voltage differential between the plating electrode and the bath, ions are freed from the NiFe bulk material and transferred to the surface of the seed layer and are deposited there. Plating of NiFe permalloy is well known in the art, and the details of this process may be found in standard references. FIG. 7 shows the condition of the substrate 10, with silicon layer 30, where in the NiFe and has been deposited within the voids formed in the substrate layer 30. It should be understood that there may be other voids in addition to 32, 34 and 36, but for clarity of depiction, only three 32, 34 and 36 are shown in FIG. 8.

FIG. 8 is a cross-sectional diagram depicting a next step in the method for forming the magnetic MEMS switch. In this step, additional voids 42 and 44 are created in the silicon layer, 30. These voids 42 and 44 may be formed as were the previous voids 32, 34 and 36 by deep reactive ion etching of the silicon substrate material through a patterned mask. These voids 42 and 44 may be uses to create metallic conductive features such as electrodes and shunt bars, as will be described further below. To create these conductive features, a metal may be plated into the voids 42, 44 by applying a new pattern to the silicon layer 30. It should be understood that there may be other voids in addition to 42 and 44, but for clarity of depiction, only two 42 and 44 are shown in FIG. 8.

FIG. 9 shows the condition of the substrate after the plating of the metallic gold material into the voids 42 and 44 of FIG. 8. The gold material maybe plated from a plating bath, using the seed layer, 20 as the electrode for the plating bath. The plating of gold proceeds in a similar manner to the plating of the NiFe, and as this process is well known in the art, details may be found in standard references.

In FIG. 10, a cross-sectional diagram is shown illustrating the next step in the method for forming the magnetic MEMS switch. In the step, another silicon layer, 300, is bonded to the original glass starting material substrate 10 using an adhesive substance 40. The bonding technique for joining these two silicon surfaces may be, once again, anodic bonding by first forming an oxide layer on at least on silicon surface. Alternatively, the bond may be made using a metal alloy or a thermocompression bond. In any case, the adhesive may be chosen with an eye to its subsequent removal, as the adhesion will need to be broken to allow the movable structure to move freely.

In some embodiments, the adhesive substance may be photoresist, which is easily dissolvable in an appropriate solvent. The surfaces are then mated and pressed together, with a voltage and/or temperature applied if appropriate. It should be noted that the figure showing the glass substrate and the inlaid gold and permalloy features have been inverted in FIG. 10 relative to FIG. 9, so that the glass layer 10 now appears on the top of the structure.

In other embodiments, the bonding methodology may be for example adhesive bond, such as a glass frit, or a metallic alloy bond such as gold/indium, or a thermocompression bond. The bond could alternatively be at oxidative bond, as well. In the illustration of FIG. 10, the adhesive layer is shown as reference number 40. It should be understood that the bonding methodology maybe any of the aforementioned techniques, as well as others known in the art. In another embodiment, the adhesive substance may be a layer of photoresist 40.

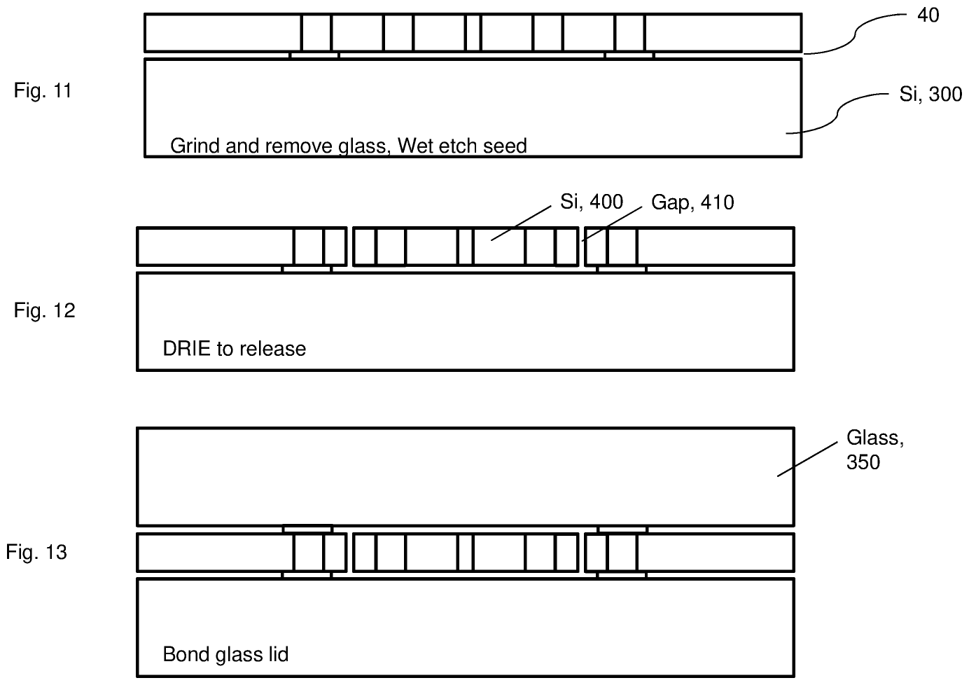

FIG. 11 shows a next step in the method for forming the magnetic MEMS switch. In FIG. 11, The glass substrate is ground off of the substrate assembly, and the seed layer 20 is etched away from this assembly as well. Grinding and wet etching may be used to remove these materials. Accordingly, in FIG. 11 all that remains may be the silicon substrate 300, the patterned and inlaid silicon layer 30 and the adhesive layer 40.

In FIG. 12, the movable portions of the switch, hereinafter referred to as the movable structure 400, are released from the adjacent stationary substrate. the portions may be freed by etching through the silicon layer 30 to create the gap XXX that defines the shape of the movable portion and to form the springs that support the moveable portion 400. The movable portion is shown generally as 400, and should be understood to include at least silicon portion 420, NiFe feature 430, and silicon portion 440 in FIG. 12. The movable structure 400 may also include restoring springs 62-68 and 72-78 described further below. Finally, the movable structure may include the gold shunt bar 460.

The gap that defines the shape of the movable portion can be created by the DRIE silicon etching process. The etched area is defined by an photoresist patterning process. It should be understood that while only a single reference number is used to refer to the movable structure 400 as a whole, movable structure 400 may include the now-inlaid voids 32, 34 and 36 and 42 and 44, which all move with movable structure 400. The clearance under the movable structure may be related to the thickness of layer 40, but may be anywhere from a few microns to tens of microns.

FIG. 12 shows the completion of the device for the bonding of a glass lid 350 on top of the previous structure shown in FIG. 11. The glass lid 350 may be anodically bonded to the silicon surface 30 as described above with respect to the other silicon surfaces. Alternatively, a polymer bonding material may be used.

FIG. 13 shows one exemplary embodiment of the MEMS magnetic switch 500 as fabricated by the process described here. It should be understood the MEMS magnetic switch 500 is exemplary only, and many other designs are contemplated, falling within the scope of the appended claims. Variations in gaps, angles, thicknesses and dimensions may be made as alternatives to MEMS magnetic switch 500, in practicing the invention.

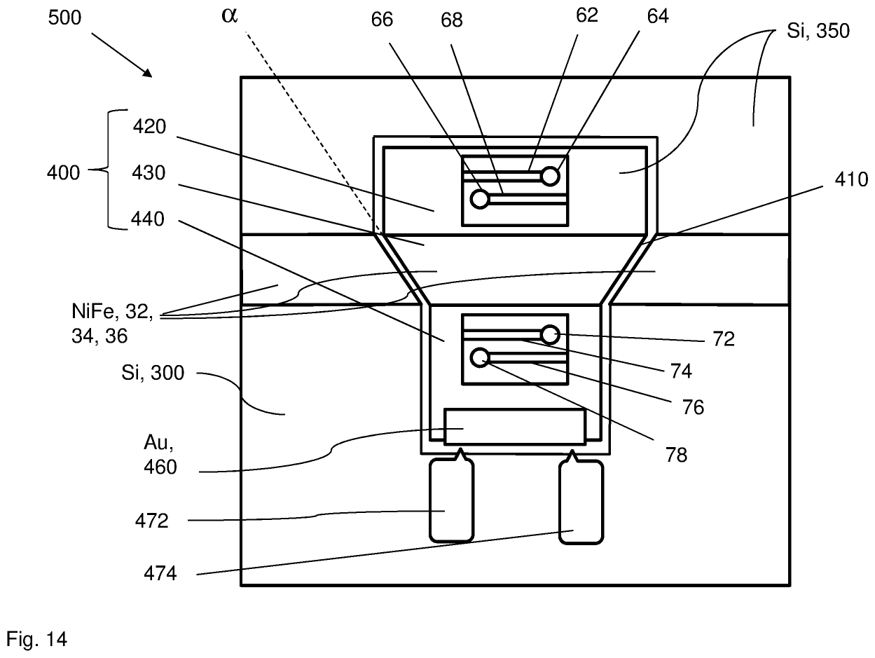

In MEMS magnetic switch 500, a gap 410 may exist around the perimeter of the movable structure 400. This gap may be large enough to allow the switch to have acceptable throw and adequate restoring force to open and close the switch. However, the gap cannot be so large that the downward (in FIG. 14) force arising from the magnetostatic interaction is insufficient to provide adequate contact force and overcome the restoring force of the springs. In some embodiments, the gap 410 is on the order of 5-10 microns.

The gap 410 may form an angle a with respect to the horizontal direction, as indicated in FIG. 14. It should be understood that this angle is exemplary only, and that other angles may be used, depending on the application. In general, the choice of angle may be a tradeoff between the magnetostatic loading force and the throw of the MEMS switch. The greater the throw, the less force is available to load the contacts. In one embodiment, the angle α may be between about 30 and about 75 degrees with respect to the direction of motion of the movable structure 400. In another embodiment, the angle α may be about 45 degrees, as shown. The angle chosen will depend in general on the requirements of the application in terms of contact resistance, working distance from magnetic source, etc. The permeable magnetic features may be disposed in a substantially straight line that is substantially perpendicular to the direction of motion as shown in FIG. 1. Accordingly, the movable structure is configured to move in a plane substantially parallel to the top surface of the substrate.

There may be two sets of two restoring springs, 62, 66, 72 and 76. These restoring springs may be thin beams of silicon substrate material that are formed by etching of the movable structure 400. These four springs 62, 66, 72 and 76 may be anchored to the remaining substrate by anchor points 64, 69, 74 and 78, which may be firmly attached to substrates 350 and 300. The restoring springs 62, 66, 72 and 76 may be about 500 microns long, 5 microns wide and 50 microns thick (the thickness of the substrate layer 30). The restoring force provided by these structures may be on the order of a milli-Newton. The two sets of two restoring springs, 62, 66, 72 and 76 may be made simultaneously with the outline of the movable structure 400 as described above.

A metallic shunt bar 460 may also be formed in the movable structure 400. The shunt bar may be formed by plating of gold, for example, into at least one of voids 42 and 44. Similarly, and input contact and output contact 470 may be formed in silicon substrate 300, using a method similar to that described above for voids 42 and 44. The shunt bar may have dimensions on the order of about 100-200 microns long, 50 microns deep (the thickness of silicon layer 30) and 10-50 microns tall.

The contacts 472, 474 formed in silicon substrate may have similar dimensions, and spaced such that the shunt bar 460 easily spans the distance between the contacts 472 and 474. The contacts with their protrusions shown in FIG. 13 may be may lithographically, because when the outline of the movable structure is formed by etching, the gold of the contacts may be impervious to the etching process, and thus they may remain raised above the surrounding surface.

It should be understood that other metallic materials other than gold, such as copper and silver, may be used in place of gold. Similarly, other permeable compounds rather than NiFe may be used in this magnetic MEMS switch.

FIG. 14 shows the structures described above with the MEMS switch 500 in the open position. In the open position, the movable structure 400 has been pulled upward by the force of the restoring spring

The entirety of movable structure 400 may include a portion of the silicon layer 420, the NiFe portion 430 (also indicated as NiFe feature 34), and the silicon substrate portion 440.

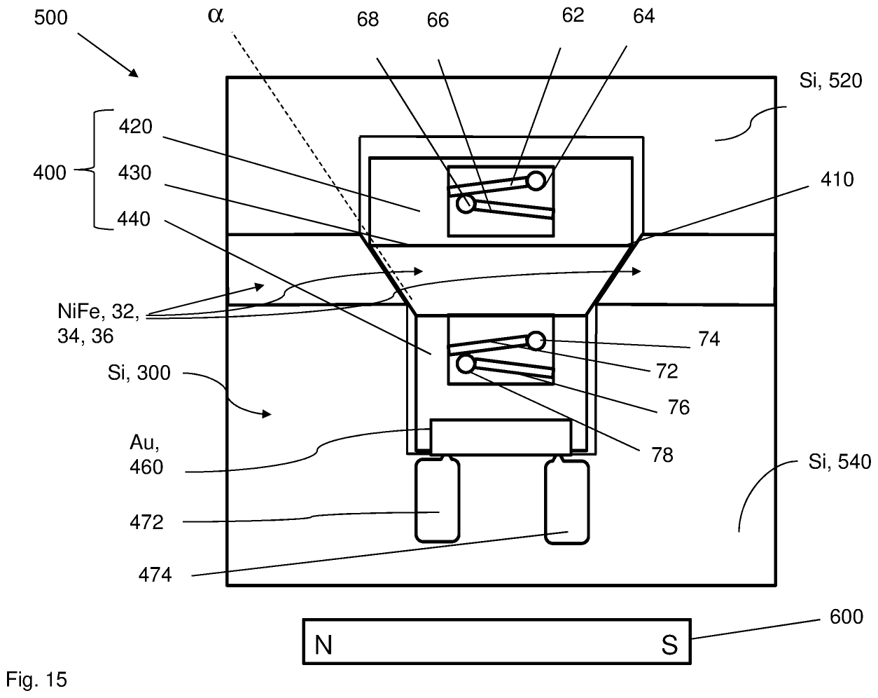

FIG. 15 is an illustration of MEMS magnetic switch 500 in the closed position. As shown in FIG. 15, a source of magnetic flux 600 is brought into proximity to the MEMS magnetic switch 500. This source of flux may be, for example, a permanent magnet or an electromagnet, wherein a permeable material is placed inside a solenoid of wire. This electromagnet may be under computer control, such that the flux is produced at specific, specified times, such as when some monitored value is achieved in a system. Alternatively, it may be a permanent magnet, as is widely used as proximity detectors in security systems. In either case, the source of magnetic flux may produce a field of about 10-1000 Gauss, and be located within about 1-10 mm from the MEMS magnetic switch 500.

Because the MEMS magnetic switch is fabricated lithographically, at the wafer level, a very large number (for example, 50,000) may be made in a batch process on a single wafer. This may make the MEMS magnetic switch exceedingly cost effective compared to other magnetic switches such as Reed relays.

Accordingly, a microfabricated magnetic MEMS switch is described. The MEMS switch may include a movable structure formed in a top surface of a substrate, wherein the movable structure is coupled to the substrate by a plurality of restoring springs anchored to the substrate and a stationary structure also formed in the same top surface of the substrate, wherein the stationary structure is anchored to the substrate and separated from the movable structure by a gap, wherein the gap is about 10 microns. The switch may also include a conductive shunt bar having a characteristic dimension of about 100 um, wherein the shunt bar is disposed on the movable structure adjacent to the gap, and an input electrode and an output electrode disposed on the stationary structure and separated by a distance of about 100 um, and also a plurality of permeable magnetic features inlaid into the stationary and movable structures, wherein the movable structure is configured to move toward the permanent structure by interaction of the permeable features with an applied magnetic field, thereby closing the gap and electrically coupling the input and output electrodes across the conductive shunt bar.

The microfabricated magnetic MEMS switch may further include a source of magnetic field flux, wherein the flux from the source is disposed within a distance of about 10 mm from the microfabricated magnetic MEMS switch. The source of magnetic flux is at least one of a permanent magnet and an electromagnet. It may also include electrical vias through a thickness of the substrate and electrically coupled to the input and the output electrodes, for transmitting a signal to the electrodes.

The restoring springs may include a length of substrate material dimensioned so as to be flexible enough to close the gap when the magnetic field is applied. The gap may have a characteristic dimension of about 10 microns, and the movable structure may move substantially in a plane of the top surface of the substrate. The magnetically permeable material may be NiFe permalloy. The permeable magnetic features are disposed is a substantially straight line that is substantially perpendicular to the direction of motion. The movable structure is configured to move in a plane substantially parallel to the top surface of the substrate.

The MEMS switch may also comprise a shunt bar disposed on the movable plate, and dimensioned to span the two contacts, and a source of magnetic flux disposed adjacent to the magnetic MEMS switch, wherein the source of magnetic flux is configured to either open or close the two electrical contacts by attracting the permeable magnetic material toward the source of magnetic flux. The plurality of restoring spring comprises 2-8 restoring springs, which each provide about 1 milli Newton of restoring force. The gap may form an angle of between about 45 and 75 degrees with respect to a direction of motion of the movable structure.

A method for fabricating the magnetic MEMS switch is also disclosed. The method may include forming a movable structure on a substrate, wherein the movable structure is coupled to the substrate by a plurality of restoring springs, and forming a stationary structure in the same top surface of the substrate, wherein the stationary structure is anchored to the substrate and separated from the movable structure by a gap, wherein the gap is about 10 microns. The method may also include inlaying a magnetic material into the movable and stationary structures, and applying a magnetic field to the movable and stationary structures, so as to cause the movable structure to be drawn toward the stationary structure, thus either opening or closing the switch.

Within the method, inlaying a magnetic material may include depositing a seed layer over a substrate. forming a second silicon surface over the seed layer, forming at least one void in the second silicon surface, and plating the permeable material into the void using the seed layer.

The method may also include providing a source of magnetic flux, wherein the flux from the source is disposed within a distance of about 10 mm from the microfabricated magnetic MEMS switch. The source of magnetic flux may be at least one of a permanent magnet and an electromagnet.

The method may further comprise forming two electrical contacts in the stationary structure, and forming a shunt bar disposed on the movable structure, wherein the shunt bar is dimensioned to span the two contacts. The plurality of restoring springs may comprise 2-8 restoring springs, each providing about 1 milli Newton of restoring force. The gap may form an angle of between about 45 and 75 degrees with respect to a direction of motion of the movable structure. The magnetic material may be NiFe permalloy, with a stoichiometry of about 80% nickel and 20% iron.

The embodiment shown in FIG. 15 is a normally open switch, wherein there is no conductor or shunt bat 260 across the input 472 and output 474 electrodes. It should be understood, however, that the MEMS magnetic switch may be configured either as a “normally open” switch or as a “normally closed” switch. The configuration may be determined by the placement and orientation of the restoring springs and anchor points 60-80.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. For example, while the disclosure describes a number of fabrication steps and exemplary thicknesses for the layers included in the MEMS switch, it should be understood that these details are exemplary only, and that the systems and methods disclosed here may be applied to any number of alternative MEMS or non-MEMS devices. Furthermore, although the embodiment described herein pertains primarily to an electrical switch, it should be understood that various other devices may be used with the systems and methods described herein, including actuators and valves, for example. Accordingly, the exemplary implementations set forth above, are intended to be illustrative, not limiting.

What is claimed is:

1. A microfabricated magnetic MEMS switch, comprising:
a movable structure formed in a top surface of a substrate, wherein the movable structure is coupled to the substrate by a plurality of restoring springs anchored to the substrate;
a stationary structure formed in the same top surface of the substrate, wherein the stationary structure is anchored to the substrate and separated from the movable structure by a gap, wherein the gap is about 10 microns;
a conductive shunt bar having a characteristic dimension of about 100 um, wherein the shunt bar is disposed on the movable structure adjacent to the gap;
an input electrode and an output electrode disposed on the stationary structure and separated by a distance of about 100 um; and
a plurality of permeable magnetic features inlaid into the stationary and movable structures, wherein the movable structure is configured to move relative to the stationary structure by interaction of the permeable features with an applied magnetic field, thereby closing the gap and electrically coupling the input and output electrodes across the conductive shunt bar.

2. The microfabricated magnetic MEMS switch of claim 1, further comprising:
a source of magnetic field flux, wherein the flux from the source is disposed within a distance of about 10mm from the microfabricated magnetic MEMS switch, thereby producing the applied magnetic field.

3. The microfabricated magnetic MEMS switch of claim 2, wherein the source of magnetic flux is at least one of a permanent magnet and an electromagnet.

4. The microfabricated magnetic MEMS switch of claim 1, further comprising:
electrical vias through a thickness of the substrate and electrically coupled to the input and the output electrodes, for transmitting a signal to the electrodes.

5. The microfabricated magnetic MEMS switch of claim 1, wherein the restoring springs comprising a length of substrate material dimensioned so as to be flexible enough to close the gap when the magnetic field is applied.

6. The microfabricated magnetic MEMS switch of claim 1, wherein the gap has a characteristic dimension of about 10 microns, and wherein the movable structure moves substantially in a plane of the top surface of the substrate.

7. The microfabricated magnetic MEMS switch of claim 1, wherein the magnetically permeable features comprises NiFe permalloy.

8. The microfabricated magnetic MEMS switch of claim 1, wherein the permeable magnetic features are disposed is a substantially straight line that is substantially perpendicular to the direction of motion.

9. The microfabricated magnetic MEMS switch of claim 1, wherein the movable structure is configured to move in a plane substantially parallel to the top surface of the substrate.

10. The magnetic MEMS switch of claim 11, further comprising:
a shunt bar disposed on the movable plate, and dimensioned to span the two contacts, and
a source of magnetic flux disposed adjacent to the magnetic MEMS switch, wherein the source of magnetic flux is configured to either open or close the two electrical contacts by attracting the permeable magnetic material toward the source of magnetic flux.

11. The magnetic MEMS switch of claim 12, wherein the plurality of restoring spring comprises 2-8 restoring springs, which each provide about 1 milli Newton of restoring force.

12. The microfabricated magnetic MEMS switch of claim 8, wherein the gap forms an angle of between about 45 and 75 degrees with respect to a direction of motion of the movable structure.

13. A method for fabricating the magnetic MEMS switch, comprising:
forming a movable structure on a substrate, wherein the movable structure is coupled to the substrate by a plurality of restoring springs;
forming a stationary structure in the same top surface of the substrate, wherein the stationary structure is anchored to the substrate and separated from the movable structure by a gap, wherein the gap is about 10 microns;
inlaying a magnetic material into the movable and stationary structures by electroplating the magnetic material; and
applying a magnetic field to the movable and stationary structures, so as to cause the movable structure to be drawn toward the stationary structure and closing the gap, thus either opening or closing the switch.

14. The method for fabricating the magnetic MEMS switch of claim 13, wherein inlaying a magnetic material comprises:
depositing a seed layer over a substrate;
forming a second silicon surface over the seed layer;
forming at least one void in the second silicon surface; and
plating the permeable magnetic material into the void using the seed layer.

15. The method for fabricating the magnetic MEMS switch of claim 13, further comprising:
providing a source of magnetic flux, wherein the flux from the source is disposed within a distance of about 10 mm from the microfabricated magnetic MEMS switch.

16. The method for fabricating the magnetic MEMS switch of claim 15, wherein the source of magnetic flux comprises at least one of a permanent magnet and an electromagnet.

17. The method for fabricating the magnetic MEMS switch of claim 13, further comprising:
forming two electrical contacts in the stationary structure; and
forming a shunt bar disposed on the movable structure, wherein the shunt bar is dimensioned to span the two contacts.

18. The method of claim 11, wherein the plurality of restoring springs comprises 8 restoring springs, each providing about 1 milli Newton of restoring force.

19. The method of claim 13, wherein the gap forms an angle of between about 45 and 75 degrees with respect to a direction of motion of the movable structure.

20. The method of claim 11, wherein the magnetic material is NiFe permalloy, about 80% nickel and 20% iron.
